(19) United States
(12) Patent Application Publication
(10) Pub. No.: US 2003/0096059 A1
(43) Pub. Date: May 22, 2003

(54) Composite material and method of producing the same

(75) Inventors: Ken Suzuki, Handa-City (JP); Shuhei Ishikawa, Handa-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/293,549

(22) Filed: Nov. 13, 2002

(30) Foreign Application Priority Data
Nov. 16, 2001 (JP) 2001-352286

(51) Int. Cl. B05D 1/32; B05D 1/36; B05D 5/00; B05D 3/02; B32B 15/04

(52) U.S. Cl. 427/282; 427/404; 427/383.1; 428/627; 428/621

(57) ABSTRACT

A composite raw material is subjected to masking, and then the composite raw material is pretreated. After that, a surface of the composite raw material is activated, and a metal catalyst is applied to a joining surface of the composite raw material and a surface of a masking tape. Subsequently, an electroless plating treatment is performed to form a plating layer on the joining surface of the composite raw material and the surface of the masking tape. It is preferable that the thickness of the plating layer is 5 to 100 μm. After that, the masking tape which has been stuck to the composite raw material is removed, and then a drying treatment is performed for the composite raw material having the plating layer formed only on the joining surface.

### BACKGROUND OF THE INVENTION

1. Field of the Invention

The present invention relates to a composite material which includes a composite raw material having a porous sintered body infiltrated with a metal and which is joined to another object by a junction layer. The present invention also relates to a method of producing the same.

2. Description of the Related Art

Nowadays, it is not sufficient to consider only the coefficient of thermal conductivity for the constitutive material for the heat sink to be used, for example, IC chips which contain CPU's. It is necessary to select a material which has approximately the same coefficient of thermal expansion as those of silicon and GaAs of semiconductor substrates and which has a high coefficient of thermal conductivity.

A variety of reports have been made in relation to the improvement of the heat sink material, including, for example, a case in which aluminum nitride (AlN) is used and a case in which Cu (copper)-W (tungsten) is used. AlN is excellent in balance between the thermal conductivity and the thermal expansion. Especially, the coefficient of thermal expansion of AlN is approximately coincident with the coefficient of thermal expansion of Si. Therefore, AlN is preferred as a heat sink material for the semiconductor material, however, residual pores exist in some degree in the composite material. Therefore, some residual liquid (machining grinding liquid and plating treatment liquid) permeates into the residual pores, and the liquid is vaporized during the soldering. As a result, voids (residual bubbles) are formed in the solder layer.

Specifically, if the plating layer formed on the surface of the composite material is thin, then non-bonded or non-adhered-portions of the plating layer exist in a scattered or dotted manner, and voids tend to appear during the soldering. In contrast, if the plating layer is thick, then swelling and exfoliation appear due to the stress brought about by the evaporation and expansion of the residual liquid during the soldering, and it is impossible to obtain the heat transfer between the raw material and the plating layer.

### SUMMARY OF THE INVENTION

It is an object of the present invention to provide a composite material which makes it possible to suppress, for example, the occurrence of cracks, swelling, and exfoliation in a plating layer and the occurrence of voids in a junction layer when the plated composite material is joined to another object by the junction layer such as a solder layer, and a method of producing the same.

According to the present invention, there is provided a composite material which includes a composite raw material device when the silicon substrate is used as the semiconductor substrate.

On the other hand, Cu—W is a composite material which is provided with both of the low thermal expansion of W and the high thermal conductivity of Cu. Further, it is easy to form a product by sintering Cu—W. Therefore, Cu—W is preferred as a material of the heat sink having a complicated shape.

As another example, Cu is contained in a ratio of 20 to 40% by volume in a ceramic base material containing SiC as a major component (see Japanese Laid-Open Patent Publication No. 8-279569). As a further example, Cu is infiltrated by 5 to 30% by weight into a powder sintered porous body (porous sintered body) of inorganic substance (see Japanese Laid-Open Patent Publication No. 59-228742).

When the composite material obtained by infiltrating Cu into the porous sintered body is used as a heat sink, the composite material is joined to a semiconductor circuit or a substrate by, for example, soldering or brazing.

However, if the composite material as described above is used, the wettability (soldering performance or brazing performance) is unsatisfactory with respect to the solder or the brazing material. Accordingly, in order to improve the wettability of the composite material, it is considered to be effective to form a plating layer on the surface of the composite material.

When the plating layer is formed on the composite having a porous sintered body infiltrated with a metal and which is joined to another object by a junction layer; the composite material comprising a plating layer formed at least on a portion of a surface of the composite raw material at which the junction layer is formed.

In this arrangement, the liquid (for example, cutting liquid and plating treatment liquid), which has remained in the composite material, is vaporized to outflow as the gas when the composite material is joined to another object by the junction layer. However, during this process, the vaporization gas keeps away from the plating layer which acts as a resistor against the permeation, and the vaporization gas flows from a portion at which the plating layer is not formed or from a portion at which the plating layer is thinly formed.

Therefore, in the present invention, it is possible to suppress, for example, the occurrence of voids in the junction layer and the occurrence of cracks, swelling, and exfoliation in the plating layer, which would be otherwise caused by the flow of the vaporization gas.

The plating layer may comprise only a first plating layer, or the plating layer may comprise the first plating layer and a second plating layer. In this arrangement, only the first plating layer may be formed at least on the portion of the surface of the composite raw material at which the junction layer is to be formed. Alternatively, the first plating layer is formed at least on the portion of the surface of the composite raw material at which the junction layer is formed, and the second plating layer is formed at least on a part of the first plating layer at which the junction layer is formed.

It is desirable that the first plating layer is formed so that a rate of voids generated in the junction layer by vaporization gas permeated through the first plating layer is not more than 5% and preferably not less than 3%. Alternatively, it is preferable that the vaporization gas of the residual liquid is not permeated through the first plating layer.

It is desirable that the first plating layer is formed so that the volume of the vaporization gas permeated through the first plating layer is not more than 5% and preferably not more than 3% of the volume of the junction layer. It is desirable that a degree of leakage of the first plating layer is not more than 5.0×10⁻¹⁰ cc-atm/sec and preferably not more than 2.0×10⁻¹⁰ cc-atm/sec.

It is preferable that the first plating layer completely coats open pores existing on the surface of the composite raw material. Alternatively, it is preferable that the first plating layer coats not less than 90% in area ratio of the open pores, the first plating layer coats not less than 95% in area ratio of the open pores, or the first plating layer coats not less than 99% in area ratio of the open pores.

At least the outermost layer of the first plating layer may be formed by electroless plating. In this arrangement, it is preferable that (1) the first plating layer is formed by electroless plating and the first plating layer has no plating crack, or (2) the first plating layer is formed by electroless plating and the first plating layer has a hardness which is not more than 80% of a maximum hardness.

At least the outermost layer of the first plating layer may be formed by electroplating. In this arrangement, it is preferable that at least the outermost layer of the first plating layer contains Ni.

Alternatively, the first plating layer may comprise a layer formed by electroless plating and a layer formed by electroplating.

It is preferable that a thickness of the first plating layer is selected so that no vaporization gas is permeated therethrough, or so that the thickness is at least twice as long as a diameter of open pore existing on the surface of the composite raw material. Specifically, the first plating layer may have a thickness of 5 to 100 μm, preferably 5 to 50 μm, more preferably 5 to 30 μm, and much more preferably 15 to 25 μm.

The first plating layer may be formed by repeating n times a series of treatments each comprising performing a drying treatment after performing a plating treatment.

On the other hand, it is preferable that a thickness of the second plating layer is selected so that residual liquid is easily vaporized and removed. It is preferable that the second plating layer allows vaporization gas of residual liquid to permeate therethrough more than at least the first plating layer allows. Specifically, the second plating layer may have a thickness of not more than 10 μm, preferably not more than 5 μm, and more preferably not more than 3 μm.

It is desirable that a degree of leakage of the second plating layer is not less than 5.0×10⁻¹⁰ cc-atm/sec and preferably not less than 1.0×10⁻⁹ cc-atm/sec.

The second plating layer may be a layer formed by electroless plating or electroplating. Alternatively, the second plating layer may comprise a layer formed by electroless plating and a layer formed by electroplating.

At least a portion of the plating layer other than the portion on which the junction layer is to be formed may be formed into a thin film by effecting processing by etching and/or polishing.

According to another aspect of the present invention, there is provided a method of producing a composite material which includes a composite raw material having a porous sintered body infiltrated with a metal and which is joined to another object by a junction layer; the method comprising a step of forming a plating layer at least on a portion of a surface of the composite raw material at which the junction layer is formed.

Accordingly, it is possible to suppress, for example, the occurrence of voids in the junction layer and the occurrence of cracks, swelling, and exfoliation in the plating layer, which would be otherwise caused by the outflow of the vaporization gas resulting from the liquid remaining in the composite raw material. Thus, it is possible to improve the yield and the quality of the composite material.

The plating layer may comprise only a first plating layer, or the plating layer may comprise the first plating layer and a second plating layer.

In this procedure, only the first plating layer may be formed at least on the portion of the surface of the composite raw material at which the junction layer is to be formed. Alternatively, the first plating layer is formed at least on the portion of the surface of the composite raw material at which the junction layer is formed, and the second plating layer is formed at least on a part of the first plating layer at which the junction layer is formed.

In the present invention, the method may comprise a step of allowing the plating layer to be not formed on surface portions other than the portion on which the first plating layer is formed. Alternatively, the method may comprise a step of applying a masking treatment to surface portions other than the portion on which the first plating layer is formed.

In the present invention, the method may comprise a step of forming the first plating layer after applying a masking treatment to the second plating layer other than a portion on which the first plating layer is formed after forming the second plating layer. Alternatively, at least the portion other than the portion on which the junction layer is to be formed may be processed by etching and/or polishing after forming the first plating layer.

It is preferable that a drying treatment is performed after forming the plating layer. In this procedure, it is preferable that a temperature and a period of time for the drying treatment are selected so that at least water is capable of being removed by vaporization.

Specifically, it is preferable that the drying treatment comprises retaining an arbitrary temperature within a range of 30 to 600° C. for an arbitrary period of time within a range of 1 to 300 minutes. More preferably, the drying treatment may comprise retaining an arbitrary temperature within a range of 200 to 400° C. for an arbitrary period of time within a range of 1 to 300 minutes. Much more preferably, the drying treatment may comprise retaining an arbitrary temperature within a range of 200 to 300° C. for an arbitrary period of time within a range of 1 to 120 minutes.

It is preferable that the drying treatment is performed in an atmosphere in which oxidation of the plating layer is suppressed. In this procedure, the atmosphere may be selected from an inert gas atmosphere, a vacuum atmosphere, and a reducing atmosphere. Especially, when the reducing atmosphere is selected, the atmosphere is preferably an atmosphere in which hydrogen is included not less than 3%, more preferably an atmosphere in which hydrogen is included not less than 30%, and much more preferably an atmosphere in which hydrogen is included not less than 90%.

It is preferable that the drying treatment is performed at a temperature-raising rate at which no swelling occurs in the first plating layer and the second plating layer. In this procedure, the temperature-raising rate is preferably not more than 400° C./hr, more preferably not more than 100° C./hr, and much more preferably not more than 50° C./hr.

It is preferable that the drying treatment is carried out in accordance with a heat program to retain a temperature in the vicinity of a vaporization temperature of residual liquid.

The first plating layer and the second plating layer may be formed by repeating n times a series of treatments each comprising performing a drying treatment after performing a plating treatment. In this procedure, it is preferable to perform a treatment to activate the plating treatment-applying surface and/or a treatment to apply a metal catalyst to the plating treatment-applying surface, before performing the plating treatment.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is, with partial cutaway, a composite material according to a first embodiment;

FIG. 2 is a sectional view in which a composite raw material of the composite material according to the first embodiment is used as a heat sink material;

FIG. 3 is a block diagram illustrating steps of a first production method;

FIG. 4 shows contents of the respective steps (No. 1);

FIG. 5 shows contents of the respective steps (No. 2);

FIG. 6 shows contents of the respective steps (No. 3);

FIG. 7 shows contents of the respective steps (No. 4);

FIG. 8 illustrates a state in which a masking tape is exfoliated in the first production method;

FIG. 9 is a sectional view illustrating a composite material according to a second embodiment;

FIG. 10 is a block diagram illustrating steps of a second production method;

FIG. 11 is a block diagram illustrating steps of a production method according to a modified embodiment of the second production method;

FIG. 12 illustrates another method of masking;

FIG. 13 is a sectional view illustrating a composite material according to a third embodiment;

FIG. 14 is a block diagram illustrating steps of a third production method;

FIG. 15 is a sectional view illustrating a composite material according to a fourth embodiment;

FIG. 16 is a block diagram illustrating steps of a fourth production method;

FIG. 17 is a table of Comparative Examples 1 and 2 and Examples 1 to 4 used in an exemplary experiment; and

FIG. 18 is a table illustrating results of the exemplary experiment.

### DESCRIPTION OF THE PREFERRED EMBODIMENTS

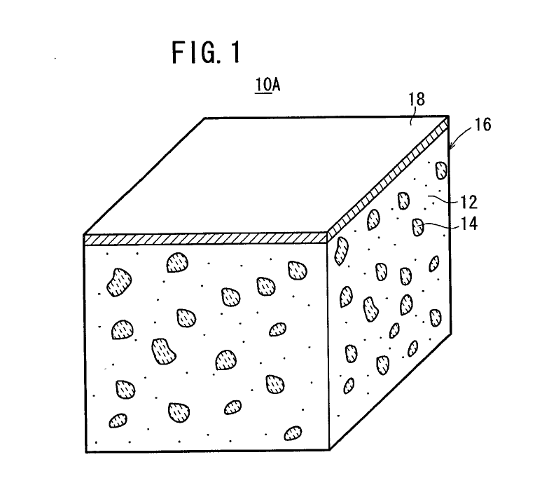

The composite material according to the present invention and the method of producing the same will be explained below with reference to FIGS. 1 to 18.

At first, as shown in FIG. 1, a composite material 10A according to a first embodiment comprises a composite raw material 16 including a porous sintered body 12 obtained by preliminarily sintering carbon, allotrope thereof, or SiC to form a network and a metal 14 infiltrated into the porous sintered body 12, and a plating layer 18 formed on a surface of the composite raw material 16. The metal 14 includes at least one selected from Cu, Al, and Ag or an alloy thereof.

In this arrangement, it is preferable to use a material having a coefficient of thermal conductivity of not less than 100 W/mK, desirably not less than 150 W/mK (estimated value in the absence of pores), and more desirably not less than 200 W/mK (estimated value in the absence of pores), as carbon, allotrope thereof, or SiC.

In this embodiment, the composite raw material 16 having the porous sintered body 12 of SiC or graphite having a coefficient of thermal conductivity of not less than 100 W/mK, and copper is infiltrated into open pores of the porous sintered body 12. The metal 14 for the infiltration includes aluminum and silver as well as copper.

As for the volume fraction between the porous sintered body 12 and the metal 14, the porous sintered body 12 is within a range of 50% by volume to 80% by volume and the metal 14 is within a range of 50% by volume to 20% by volume. Accordingly, the coefficient of thermal conductivity of the composite raw material 16 is not less than 180 to 220 W/mK and the coefficient of thermal expansion of the composite raw material 16 is 4×10⁻⁶/° C. to 7×10⁻⁶/° C.

It is desirable that the porosity of the porous sintered body 12 is 10% by volume to 50% by volume. If the porosity is less than 10% by volume, it is impossible to obtain the coefficient of thermal conductivity of 180 W/mK (room temperature). If the porosity is above 50% by volume, then the strength of the porous sintered body 12 is lowered, and it is impossible to suppress the coefficient of thermal expansion to be not more than 15.0×10⁻⁶/° C.

It is desirable that the average open pore diameter (pore diameter) of the porous sintered body 12 has a value within a range of 0.1 to 200 μm. If the pore diameter is less than 0.1 μm, it is difficult to infiltrate the metal 14 into the open pores, and the coefficient of thermal conductivity is lowered. On the other hand, if the pore diameter exceeds 200 μm, then the strength of the porous sintered body 12 is lowered, and it is impossible to suppress the coefficient of thermal expansion to be low.

As for the distribution (pore distribution) concerning the average open pore diameter of the porous sintered body 12, it is preferable that the pores within a range of 0.5 to 50 μm are distributed not less than 90% by volume. If the pores of 0.5 to 50 μm are not distributed by not less than 90% by volume, then the open pores, into which the metal 14 is not infiltrated, are increased, and the coefficient of thermal conductivity may be lowered.

The closed porosity of the composite raw material 16 obtained by infiltrating the porous sintered body 12 with the metal 14 is preferably not more than 5% by volume. If the closed porosity exceeds 5% by volume, the coefficient of thermal conductivity may be lowered.

The porosity, the pore diameter, and the pore distribution were measured by using an automatic porosimeter produced by Shimadzu Corporation (trade name: “Autopore 9200”.

If graphite is used in the composite material 10A, for example, it is preferable to add an additive which reduces the closed porosity when the graphite is preliminarily sintered. The additive may be exemplified by SiC and/or Si. Accordingly, it is possible to decrease the closed pores in sintering, and it is possible to improve the rate of infiltration of the metal 14 into the porous sintered body 12.

An element may be added to graphite for reacting with the graphite to form a carbide layer. The additive element may be exemplified by one or more elements selected from Nb, Cr, Zr, Be, V, Mo, Al, Ta, Mn, Si, Fe, Co, Ni, Mg, Ca, W, Ti, B, and misch metal. Accordingly, a reaction layer (carbide layer) is formed on the surface of graphite (including the surfaces of the open pores) during sintering graphite, the wettability with the metal 14 infiltrated into the open pores of graphite is improved, and the infiltration can be performed at a low pressure. Further, the metal 14 can be also infiltrated into fine open pores.

On the other hand, it is preferable to add one or more elements selected from Te, Bi, Pb, Sn, Se, Li, Sb, Tl, Ca, Cd, and Ni to the metal 14 to be infiltrated into the porous sintered body 12. Accordingly, the wettability is improved at the interface between the porous sintered body 12 and the metal 14, and the metal 14 easily enters the open pores of the porous sintered body 12. Especially, Ni has an effect that carbon is easily dissolved and the infiltration is facilitated.

Further, it is preferable to add one or more elements selected from Nb, Cr, Zr, Be, Ti, Ta, V, B, and Mn to the metal 14 infiltrated into the porous sintered body 12. Accordingly, the reactivity between the graphite and the metal 14 is improved, the graphite and the metal 14 easily contact tightly in the open pores, and it is possible to suppress the generation of closed pores.

Further, it is preferable to add an element having a temperature range of solid phase/liquid phase of not less than 30° C. and desirably not less than 50° C., for example, one or more elements selected from Sn, P, Si, and Mg to the metal 14 infiltrated into the porous sintered body 12. If added, it is possible to reduce the dispersion during the infiltration. Further, it is preferable to add an element to the metal 14 in order to lower the melting point. Such an additive element includes Zn.

Some residual pores exist in the composite raw material 16 described above. Therefore, when the plating layer 18 is formed on the surface of the composite raw material 16, some machining grinding liquid and/or some plating treatment liquid permeates into the residual pores, and the liquid is vaporized during the soldering to form voids (residual bubbles) in the solder layer in ordinary cases.

However, in the composite material 10A, the plating layer 18 on the surface of the composite raw material 16 is formed by performing the following steps. The plating layer 18 is formed at least at the portion of the surface of the composite raw material 16 on which the solder layer is to be formed.

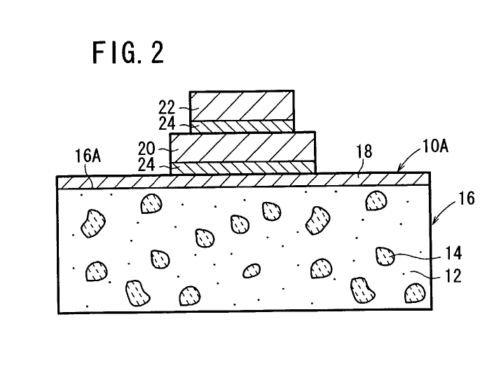

For example, it is assumed that the composite raw material 16 is used as a heat sink material. As shown in FIG. 2, for example, an IC chip 22 is mounted on the composite raw material 16 with an insulating substrate 20 interposed therebetween. The composite raw material 16 is joined to the insulating substrate 20 and the IC chip 22 is joined to the insulating substrate 20, for example, by the solder layers 24. In order to improve the wettability of the composite raw material 16 with the solder layer 24, the plating layer 18 is formed on the joining surface 16a (for example, the upper surface) of the entire surface of the composite raw material 16 on which the solder layer 24 is to be formed, and the plating layer 18 is not formed on the other surfaces (for example, the lower surface and the four side surfaces).

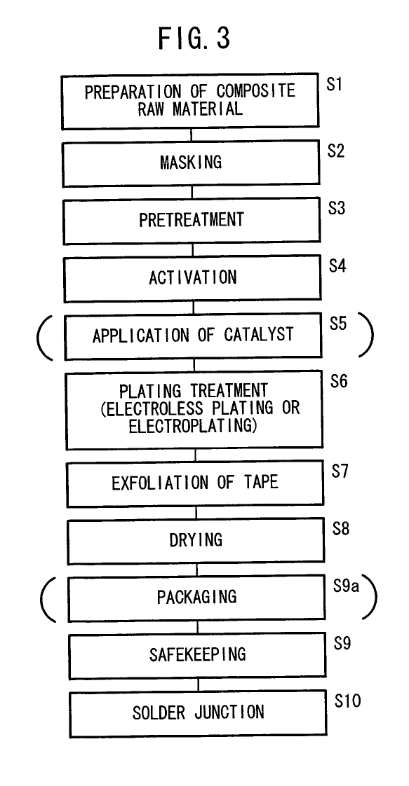

An explanation will now be made with reference to FIGS. 3 to 8 about a specified example (first production method) of the method of producing the composite material 10A.

In the first production method, at first, in Step S1 shown in FIG. 3, the composite raw material 16 is prepared, in which the metal 14 is infiltrated into the porous sintered body 12 obtained by preliminarily sintering carbon, allotrope thereof, or SiC to form a network.

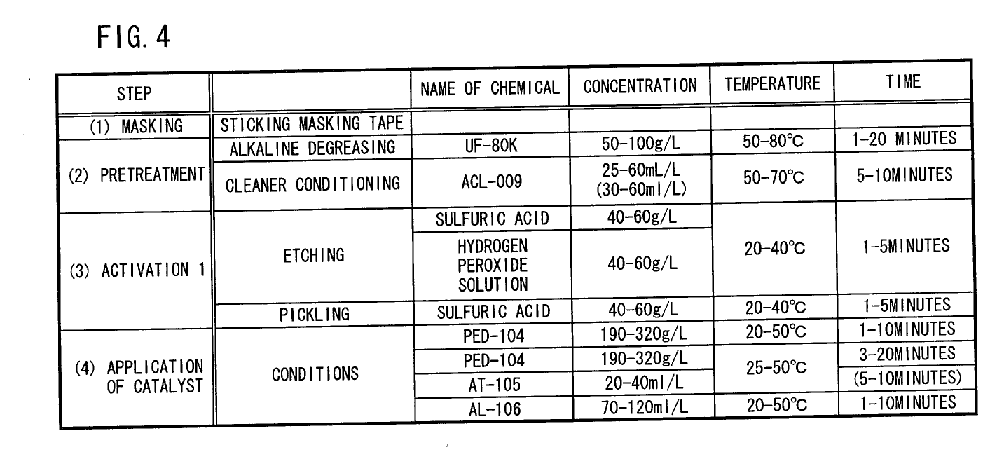

After that, in Step S2, the composite raw material 16 is subjected to the masking. In the masking, as shown in the step of “(1) Masking” in FIG. 4, for example, a masking tape is stuck to the surfaces (for example, the lower surface and the four side surfaces) except for the joining surface 16a of the entire surface of the substantially rectangular parallelepiped composite raw material 16. Of course, for example, an ordinary photoresist film can be used in place of the masking tape.

After that, in Step S3, a pretreatment is performed for the composite raw material 16 having been subjected to the masking. As shown in the step of “(2) Pretreatment” in FIG. 4, for example, the pretreatment includes an alkaline degreasing treatment and a cleaner conditioner treatment. FIG. 4 shows examples of chemicals, concentrations, and temperatures to be used in the pretreatment. In FIG. 4, both of UF-80K and ACL-009 are chemicals produced by C. Uyemura & Co., Ltd.

After that, in Step S4 shown in FIG. 3, the surface of the composite raw material 16 is subjected to an activation treatment. As shown in the step of “(3) Activation 1” in FIG. 4, for example, the activation treatment includes an etching treatment and a pickling treatment. FIG. 4 shows examples of chemicals, concentrations, and temperatures to be used in the activation treatment.

When an electroless plating treatment is performed thereafter, a metal catalyst is applied at least to the joining surface 16a of the composite raw material 16 in Step S5 shown in FIG. 3 prior to the electroless plating treatment. Conditions (chemicals, concentrations, and temperatures) of the metal catalyst application are shown, for example, in the columns of the step of “(4) Application of catalyst” in FIG. 4. In FIG. 4, all of PED-104, AT-105, and AT-106 are chemicals produced by C. Uyemura & Co., Ltd.

When an electroplating treatment is performed in place of the electroless plating treatment, the step (Step S5 shown in FIG. 3) can be omitted as described later on. Therefore, in FIG. 3, Step S5 is depicted in parentheses.

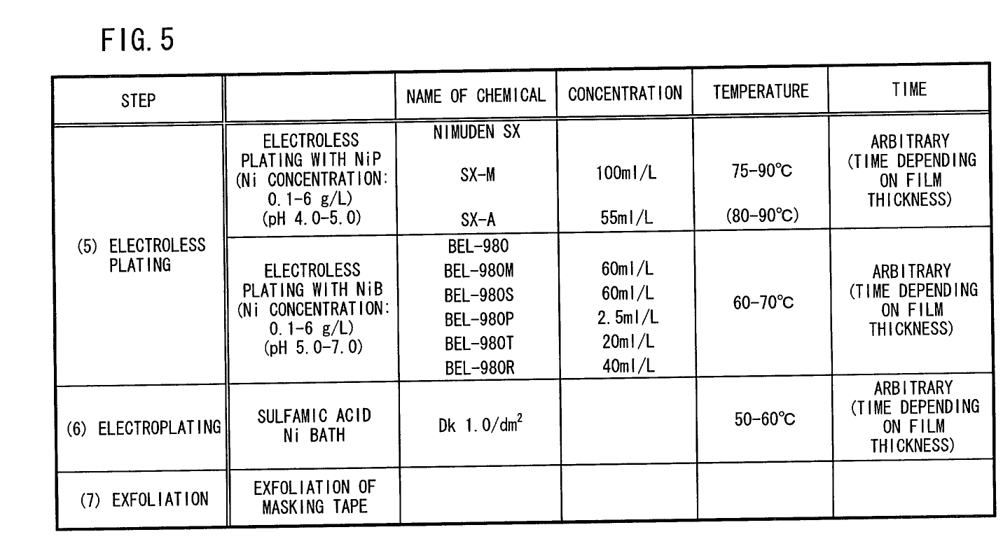

After that, in Step S6 shown in FIG. 3, the electroless plating treatment is performed to form the plating layer 18 at least on the joining surface 16a of the composite raw material 16. As shown in the step of “(5) Electroless plating” in FIG. 5, for example, the electroless plating treatment includes the execution of an electroless plating treatment with NiB after performing an electroless plating treatment with NiP. Conditions of the electroless plating treatments are shown in FIG. 5. In FIG. 5, all of Nimuden SX, SX-M, SX-A, BEL-980, BEL-980M, BEL-980S, BEL-980P, BEL980T, and BEL-980R are chemicals produced by C. Uyemura & Co., Ltd.

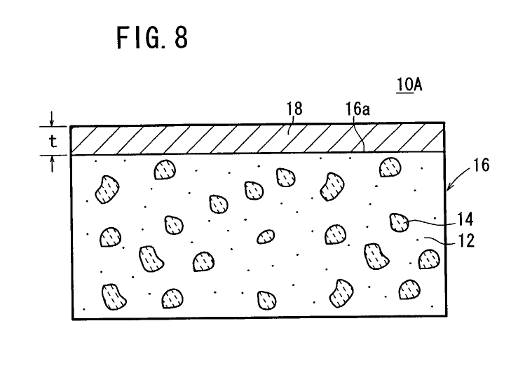

The thickness t of the plating layer 18 (see FIG. 8) is suitably selected so that the vaporization gas of the liquid remaining in the composite raw material 16 is not permeated through the plating layer 18, or so that the open pores existing in the composite raw material 16 can be coated. The thickness by which the open pores existing in the composite raw material 16 can be coated herein means a thickness which is about twice as long as the average diameter of the open pores existing in the composite raw material 16.

As for the permeation of the vaporization gas (degree of leakage), the degree of leakage of the plating layer 18 is preferably not more than 5.0×10⁻¹⁰ cc-atm/sec, and more preferably not more than 2.0×10⁻¹⁰ cc-atm/sec.

Specifically, the thickness t of the plating layer 18 is 5 to 100 μm, preferably 5 to 50 μm, more preferably 5 to 30 μm, and much more preferably 15 to 25 μm.

After that, in Step S7 shown in FIG. 3, an exfoliation treatment for the masking tape is performed. This treatment can be performed, for example, such that the side surface of the plating-treated composite raw material 16 is pinched, by using tweezers or the like to expose the masking tape from the plating layer 18, and then the masking tape is exfoliated. As a result of the exfoliation treatment, as shown in FIG. 8, the plating layer 18 remains only on the joining surface 16a of the composite raw material 16.

When a photoresist film is used in place of the masking tape, the treatment is performed by immersing the plated composite raw material 16 in a liquid in which the photoresist film is dissolved. As a result of this treatment, the plating layer 18, which has been formed on the surface of the photoresist film, is removed together with the photoresist film (lift-off method). Consequently, as shown in FIG. 8, the plating layer 18 remains only on the joining surface 16a of the composite raw material 16.

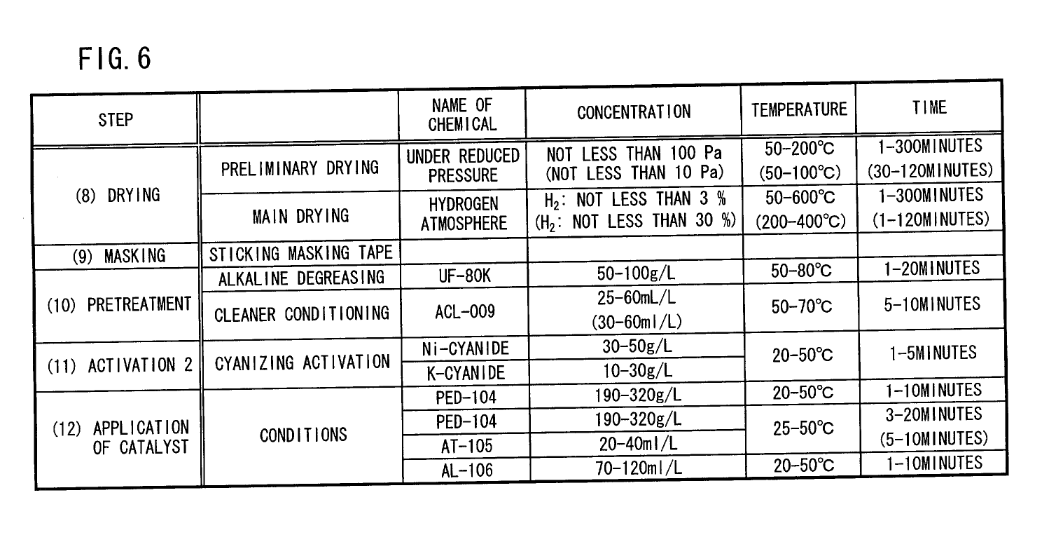

After that, in Step S8 shown in FIG. 3, a drying treatment is performed for the composite raw material 16 having the plating layer 18 formed on the joining surface 16a. As shown in the step of “(8) Drying” in FIG. 6, for example, the drying treatment includes performing preliminary drying and then performing main drying. FIG. 6 shows conditions of the preliminary drying and the main drying. The drying treatment is preferably performed in an atmosphere in which oxidation of the plating layer 18 is suppressed, for example, in a reducing atmosphere, an inert gas atmosphere, or in a vacuum atmosphere. In fact, the drying treatment step is suitably performed such that the vaporization and the removal of residual matters are carried out under a condition in which no oxidation occurs. Therefore, in order to suppress the oxidation, the atmosphere for the drying treatment is an atmosphere in which hydrogen is not less than 3%, desirably an atmosphere in which hydrogen is not less than 30%, and more desirably an atmosphere in which hydrogen is not less than 90%.

The drying treatment is suitably carried out at a certain temperature and for a certain period of time so that at least water can be vaporized and removed. It is preferable that the drying treatment is performed so that the hardness of the plating layer 18 is a hardness of not more than 80% of the maximum hardness, or HV is not more than 750.

An explanation will now be made about the cause to generate cracks in the plating layer 18. For example, in the case of the NiP plating layer, the aging deposition of the plating layer 18 causes, for example, the increase in hardness, the decrease in ductility, and the shrinkage of dimension of the plating layer 18 itself. As a result, cracks may appear due to the failure to follow the difference in thermal stress between the plating layer 18 and the composite raw material 16 as the base material. It has been revealed that the aging deposition is caused depending on the thermal hysteresis of the drying treatment performed, for example, after the plating treatment.

Accordingly, in order to avoid the occurrence of cracks in the plating layer 18, it is preferable to perform the treatment in accordance with a heat program based on the temperature and the time which satisfy the conditions as described above. Specifically, in the drying treatment, it is preferable that an arbitrary temperature within a range of 30 to 600° C. is retained for an arbitrary period of time within a range of 1 to 300 minutes. More preferably, an arbitrary temperature within a range of 200 to 400° C. is retained for an arbitrary period of time within a range of 1 to 300 minutes. Much more preferably, an arbitrary temperature within a range of 200 to 300° C. is retained for an arbitrary period of time within a range of 1 to 120 minutes.

The drying treatment is suitably performed at a temperature-raising rate which causes no swelling in the plating layer 18. In this procedure, the temperature-raising rate is preferably not more than 400° C./hr, more preferably not more than 200° C./hr, and much more preferably not more than 50° C./hr.

At the stage at which the drying treatment in Step S8 comes to an end, the composite material 10A according to the first embodiment is completed. After that, the composite material 10A is in safekeeping in Step S9. Alternatively, the composite material 10A is packaged (Step S9a depicted in parentheses) and shipped, and it is in safekeeping, for example, by a user.

If necessary, the composite material 10A, which has been in safekeeping, is subjected to the solder junction (Step S10).

For example, as shown in FIG. 2, when the insulating substrate 20 is joined via the solder layer 24 to the heat sink material of the composite raw material 16, the liquid (for example, the cutting liquid and the plating treatment liquid), which remains in the composite raw material 16, vaporizes and outflows as the gas. During this process, the vaporization gas keeps away from the plating layer 18 which serves as the resistor against the permeation, and the gas outflows from portions at which the plating layer 18 is not formed.

Accordingly, the composite material 10A suppresses, for example, the occurrence of cracks, swelling, and exfoliation in the plating layer 18 and the occurrence of voids in the solder layer 24 which would be otherwise caused by the outflow of the vaporization gas.

When the composite material 10A is in safekeeping, then the composite material 10A may be packaged by using a material having high sealing performance such as aluminum foil, and some desiccating agent may be used in combination to maintain the quality obtained just after the sinter treatment. When the treatment as described above is applied, it is possible to avoid the occurrence of voids during the solder junction after the safekeeping.

The embodiment described above is illustrative of the case in which the plating layer 18 is formed by the electroless plating treatment. Alternatively, the plating layer 18 may be formed by the electroplating treatment. In this procedure, it is possible to omit the catalyst application step in Step S5 shown in FIG. 3. The electroplating treatment performed in Step S6 can be carried out, for example, under the condition as shown in the step of “(6) Electroplating” in FIG. 5.

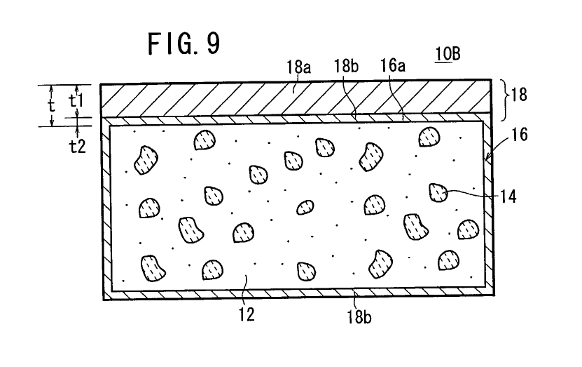

Next, a composite material 10B according to a second embodiment will be explained with reference to FIG. 9.

The composite material 10B is constructed in approximately the same manner as the composite material 10A as described above. However, as shown in FIG. 9, the composite material 10B is different from the composite material 10A in that a thin plating layer 18b is formed on the surface of the composite raw material 16, and a thick plating layer 18a is formed at least at a portion on which the solder layer 24 (see FIG. 2) is to be formed, of the surface of the composite raw material 16 on which the thin plating layer 18b has been formed. Therefore, a laminated plating layer 18, which comprises the lower layer of the thin plating layer 18b and the upper layer of the thick plating layer 18a, is formed on the joining surface 16a of the composite raw material 16.

In the composite material 10B, when the insulating substrate 20 is joined via the solder layer 24 to the heat sink material of the composite raw material 16, the liquid (for example, the cutting liquid and the plating treatment liquid), which remains in the composite raw material 16, vaporizes and outflows as the gas. During this process, the vaporization gas keeps away from the portion at which the laminated plating layer 18 to serve as the resistor against the permeation is formed, and the gas outflows through the portion at which the thin plating layer 18b is formed.

Accordingly, the composite material 10B also suppresses, for example, the occurrence of cracks, swelling, and exfoliation in the laminated plating layer 18 and the occurrence of voids in the solder layer 24 which would be otherwise caused by the outflow of the vaporization gas.

Especially, in the composite material 10B, the thin plating layer 18b is formed on the surface. Therefore, the composite material 10B is handled in a well-suited manner during the soldering. Further, the appearance is satisfactory, and it is possible to reduce the absorption of humidity.

Next, an explanation will be made with reference to FIGS. 4 to 7 and FIGS. 9 and 10 about a specified example (second production method) of the method of producing the composite material 10B. The steps same as the ones in the first production method described above will not be detailed.

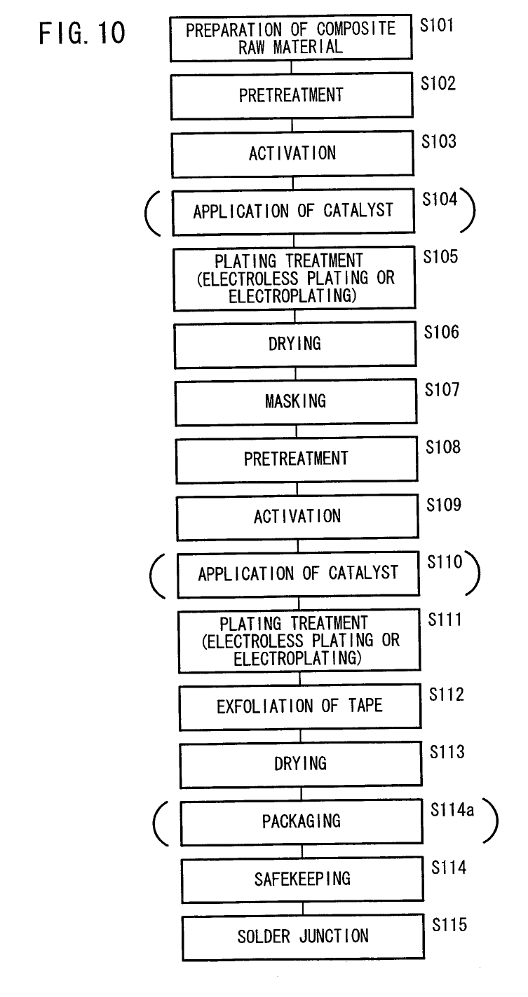

At first, in Step S101 shown in FIG. 10, the composite raw material 16 is prepared. Subsequently, a pretreatment is performed-for the composite raw material 16 in Step S102. As shown in the step of “(2) Pretreatment” in FIG. 4, for example, the pretreatment includes an alkaline degreasing treatment and a cleaner conditioner treatment.

After that, in Step S103 shown in FIG. 10, the surface of the composite raw material 16 is subjected to an activation treatment. As shown in the step of “(3) Activation 1” in FIG. 4, for example, the activation treatment includes an etching treatment and a pickling treatment.

When an electroless plating treatment is performed thereafter, a metal catalyst is applied to the surface of the composite raw material 16 in Step S104 shown in FIG. 10 prior to the electroless plating treatment. Conditions (chemicals, concentrations, and temperatures) of the metal catalyst application are shown, for example, in the columns of the step of “(4) Application of catalyst” in FIG. 4.

When an electroplating treatment is performed in place of the electroless plating treatment, the step (Step S104) can be omitted as described above. Therefore, in FIG. 10, Step S104 is depicted in parentheses.

After that, in Step S105, the electroless plating treatment is performed to form the thin plating layer 18b on the entire surface of the composite raw material 16 as shown in FIG. 9. The electroless plating treatment includes an electroless plating treatment with NiP, for example, in the step of “(5) Electroless plating” shown in FIG. 5.

The thickness t2 of the thin plating layer 18b is suitably selected so that the residual liquid is easily vaporized and removed, or so that the vaporization gas of the residual liquid is easily permeated at least as compared with the thin plating layer 18a (see FIG. 9).

As for the permeation of the vaporization gas (degree of leakage), the degree of leakage of the thin plating layer 18b is preferably not more than 5.0×10⁻¹⁰ cc-atm/sec, and more preferably not more than 1.0×10⁻⁹ cc-atm/sec.

Specifically, the thickness t2 of the thin plating layer 18b is not more than 10 μm, preferably not more than 5 μm, and more preferably not more than 3 μm.

After that, in Step S106, a drying treatment is performed for the composite raw material 16 having the thin plating layer 18b formed on the surface. As shown in the step of “(8) Drying” in FIG. 6, for example, the drying treatment includes performing preliminary drying and then performing main drying.

After that, in Step S107 shown in FIG. 10, the composite raw material 16 having the thin plating layer 18b formed on the surface is subjected to the masking. In the masking, as shown in the step of “(9) Masking” in FIG. 6, for example, a masking tape is stuck to the surfaces (for example, the lower surface and the four side surfaces) except for the joining surface 16a of the entire surface of the composite raw material 16 having the thin plating layer 18b formed on the entire surface. Of course, for example, a photoresist film can be used in place of the masking tape.

After that, in Step S108, a pretreatment is performed for the composite raw material 16 having been subjected to the masking. As shown in the step of “(10) Pretreatment” in FIG. 6, for example, the pretreatment includes an alkaline degreasing treatment and a cleaner conditioner treatment. FIG. 6 shows examples of chemicals, concentrations, and temperatures to be used in the pretreatment.

After that, in Step S109 shown in FIG. 10, the surface of the composite raw material 16 is subjected to an activation treatment. As shown in the step of “(11) Activation 2” in FIG. 6, for example, the activation treatment includes a cyanizing activation treatment. FIG. 6 shows examples of chemicals, concentrations, and temperatures to be used in the activation treatment.

When an electroless plating treatment is performed thereafter, a metal catalyst is applied at least to the joining surface 16a (surface at which the thin plating layer 18b is exposed) of the composite raw material 16 in Step S110 shown in FIG. 10 prior to the electroless plating treatment. Conditions (chemicals, concentrations, and temperatures) of the metal catalyst application are shown, for example, in the columns of the step of “(12) Application of catalyst” in FIG. 6. When an electroplating treatment is performed in place of the electroless plating treatment, the step (Step S110 shown in FIG. 10) can be omitted as described later on.

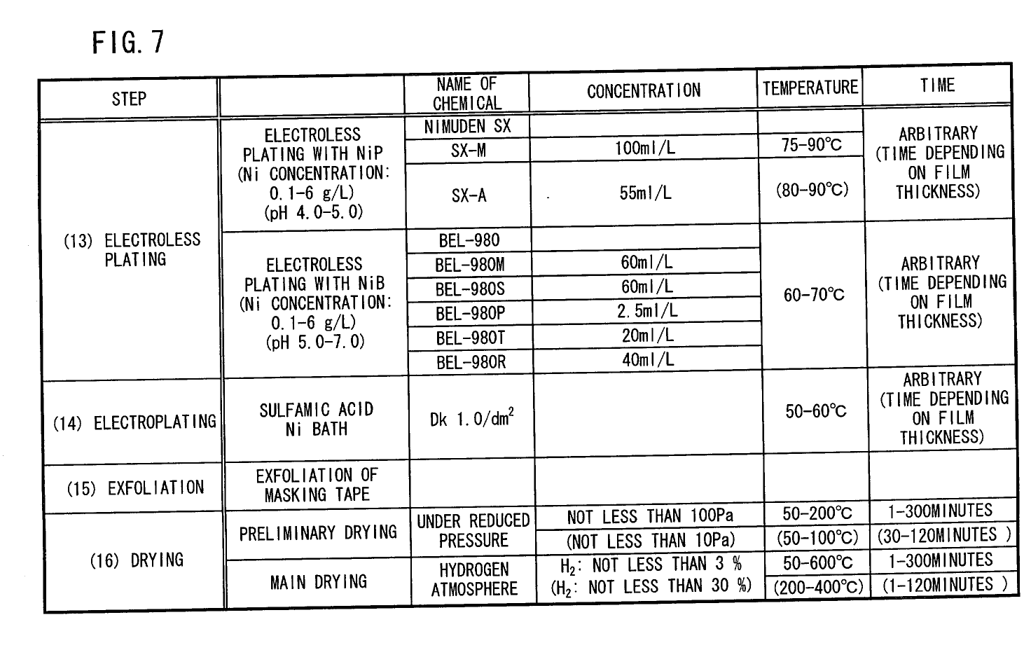

After that, in Step S111, the electroless plating treatment is performed to form the thick plating layer 18a at least on the joining surface 16a (surface at which the thin plating layer 18b is exposed) of the composite raw material 16. As shown in the step of “(13) Electroless plating” in FIG. 7, for example, the electroless plating treatment includes the execution of an electroless plating treatment with NiB after performing an electroless plating treatment with NiP. Conditions of the electroless plating treatments are shown in FIG. 7.

As a result of the plating treatment, the laminated plating layer 18, which comprises the thin plating layer 18b and the thick plating layer 18a, is formed on the joining surface 16a of the composite raw material 16.

The thickness t (=t1+t2, see FIG. 9) of the laminated plating layer 18 is suitably selected so that the vaporization gas of the liquid remaining in the composite raw material 16 is not permeated through the laminated plating layer 18, or so that the open pores existing in the composite raw material 16 can be coated, in the same manner as in the plating layer 18 of the composite material 10A described above. Specifically, the thickness t of the laminated plating layer 18 is 5 to 100 μm, preferably 5 to 50 μm, more preferably 5 to 30 μm, and much more preferably 15 to 25 μm.

After that, in Step S112 shown in FIG. 10, an exfoliation treatment for the masking tape is performed. As a result of this treatment, as shown in FIG. 9, the laminated plating layer 18 remains on the joining surface 16a of the composite raw material 16, and the thin plating layer 18b remains on the lower surface and the four side surfaces of the composite raw material 16.

After that, in Step S113, a drying treatment is performed for the composite raw material 16 having the laminated plating layer 18 formed on the joining surface 16a. As shown in the step of “(16) Drying” in FIG. 7, for example, the drying treatment includes performing preliminary drying and then performing main drying. FIG. 7 shows conditions of the preliminary drying and the main drying.

Preferred embodiments (for example, atmospheres, hardnesses, temperatures, times, and temperature-raising rates) in Step S106 and Step S113 are equivalent to those used for the composite material 10A described above. Therefore, the explanation thereof is omitted herein.

When the drying treatment in Step S113 comes to an end, the composite material 10B is completed. After that, the composite material 10B is in safekeeping in Step S114. Alternatively, the composite material 10B is packaged (Step S114a depicted in parentheses) and shipped, and it is in safekeeping, for example, by a user.

When necessary, the composite material 10B, which has been in safekeeping, is subjected to the solder junction (Step S115).

The embodiment described above is illustrative of the case in which both of the thin plating layer 18b and the thick plating layer 18a are formed by the electroless plating treatment. Alternatively, the thin plating layer 18b may be formed by the electroless plating and the thick plating layer 18a may be formed by the electroplating treatment. It is of course allowable that both of the thin plating layer 18b and the thick plating layer 18a are formed by the electroplating treatment. When the electroplating treatment is performed, it is possible to omit the catalyst application step in Step S104 and Step S110 shown in FIG. 10. When the thin plating layer 18b is formed by the electroplating treatment, the electroplating treatment can be performed, for example, under the condition as shown in the step of “(6) Electroplating” in FIG. 5. When the thick plating layer 18a is formed by the electroplating treatment, the electroplating treatment can be performed, for example, under the condition as shown in the step of “(14) Electroplating” in FIG. 7.

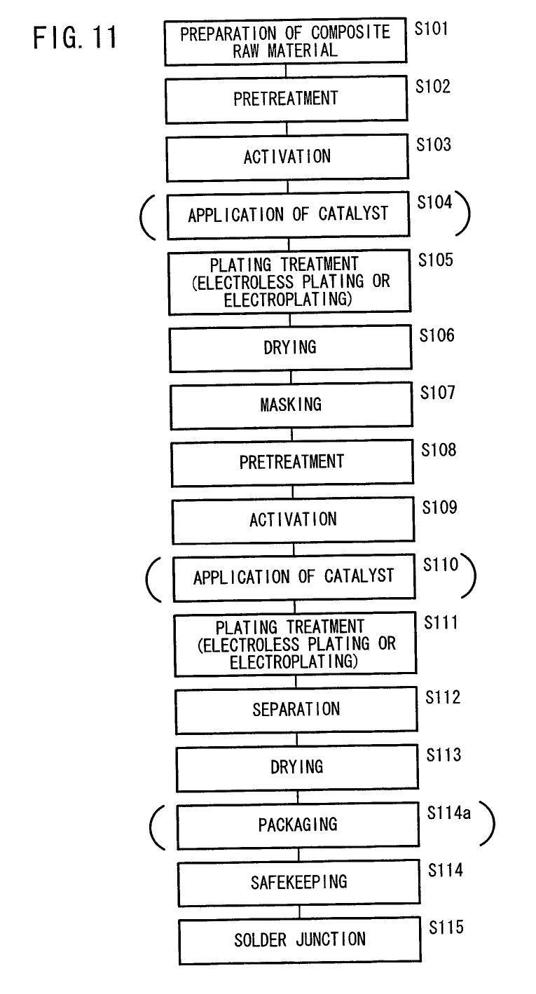

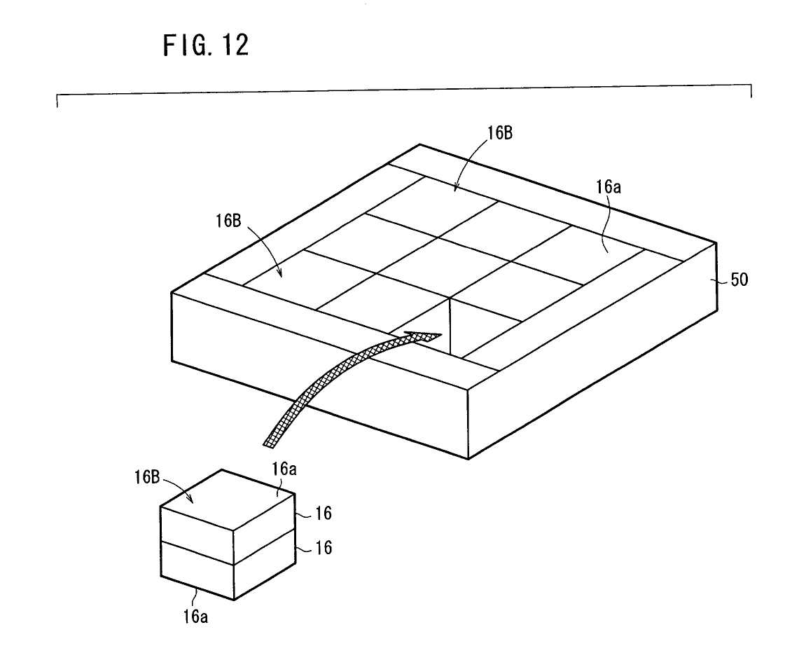

Next, an explanation will be made with reference to FIGS. 11 and 12 about another specified example (production method according to a modified embodiment) of the method of producing the composite material 10B.

The production method according to this modified embodiment includes approximately the same steps as those of the second production method described above. However, the former is different from the latter in the masking treatment in Step S107. Specifically, as shown in FIG. 12, one set of block 16B is prepared by vertically superimposing the two composite raw materials 16 each having the thin plating layer 18b formed on the entire surface. In this form, several sets of the blocks 16B are aligned and accommodated in a frame 50. Then, the composite raw materials 16 are forwarded to the next step.

The surfaces (lower surface and four side surfaces) other than one surface (joining surface 16a) of each of the composite raw materials 16 are hidden by the adjoining composite raw materials 16 or by the frame 50. Accordingly, in this form, only the joining surface 16a of each of the composite raw materials 16 is exposed. Of course, the composite raw materials 16 may be forwarded to the next step with the block 16B in which two of the composite raw materials 16 are combined.

After that, the pretreatment in Step S108 shown in FIG. 11, the activation treatment in Step S109, the catalyst application in Step S110 (omitted when the electroplating treatment is performed thereafter), and the plating treatment in Step S111 (formation of the thin plating layer 18a) are performed. Accordingly, as shown in FIG. 9, the thick plating layer 18a is formed on only the joining surface 16a of the composite raw material 16. The laminated plating layer 18, which comprises the thick plating layer 18a and the thin plating layer 18b, is formed on the joining surface 16a of the composite raw material 16 by the plating treatment.

After that, in Step S112 shown in FIG. 11, the frame 50 shown in FIG. 12 is disassembled or removed to separate the several sets of blocks 16B into the individual composite raw materials 16. After that, the drying treatment in Step S113 is performed, and thus the composite material 10B according to the second embodiment is obtained.

In this method, the masking tape is unnecessary provided that only the frame 50 is prepared. Therefore, this method is also advantageous in view of the cost. Further, a large number of composite raw materials 16 can be treated at once. Therefore, this method is advantageous to reduce the number of steps.

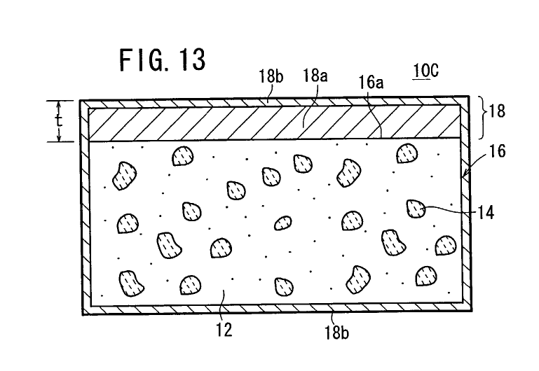

Next, a composite material 10C according to a third embodiment will be explained with reference to FIG. 13.

The composite material 10C is constructed in approximately the same manner as the composite material 10B described above. However, as shown in FIG. 13, the composite material 10C is different from the composite material 10B in that a thick plating layer 18a is directly formed at least on a portion (joining surface 16a) of the composite raw material 16 on which the solder layer 24 (see FIG. 2) is to be formed, and a thin plating layer 18b is formed on the surface of the composite raw material 16 on which the thick plating layer 18a has been formed (including the surface of the thick plating layer 18a). Therefore, in this form, a laminated plating layer 18, which comprises the lower layer of the thick plating layer 18a and the upper layer of the thin plating layer 18b, is formed on the joining surface 16a of the composite raw material 16.

In the composite material 10C, when the insulating substrate 20 is joined via the solder layer 24 to the heat sink material of the composite raw material 16, the liquid (for example, the cutting liquid and the plating treatment liquid), which remains in the composite raw material 16, vaporizes and outflows as the gas in the same manner as in the composite material 10B described above. During this process, the vaporization gas keeps away from the portion at which the laminated plating layer 18 to serve as the resistor against the permeation is formed, and the gas outflows through the portion at which the thin plating layer 18b is formed.

Accordingly, the composite material 10C also suppresses, for example, the occurrence of cracks, swelling, and exfoliation in the laminated plating layer 18 and the occurrence of voids in the solder layer 24 which would be otherwise caused by the outflow of the vaporization gas.

Further, in the composite material 10C, the thin plating layer 18b is formed on the surface. Therefore, the composite material 10C is handled in a well-suited manner during the soldering. Further, the appearance is satisfactory, and it is possible to reduce the absorption of humidity.

Next, an explanation will be made with reference to FIGS. 4 to 7 and FIG. 14 about a specified example (third production method) of the method of producing the composite material 10C. The steps same as the ones in the second production method described above will not be detailed.

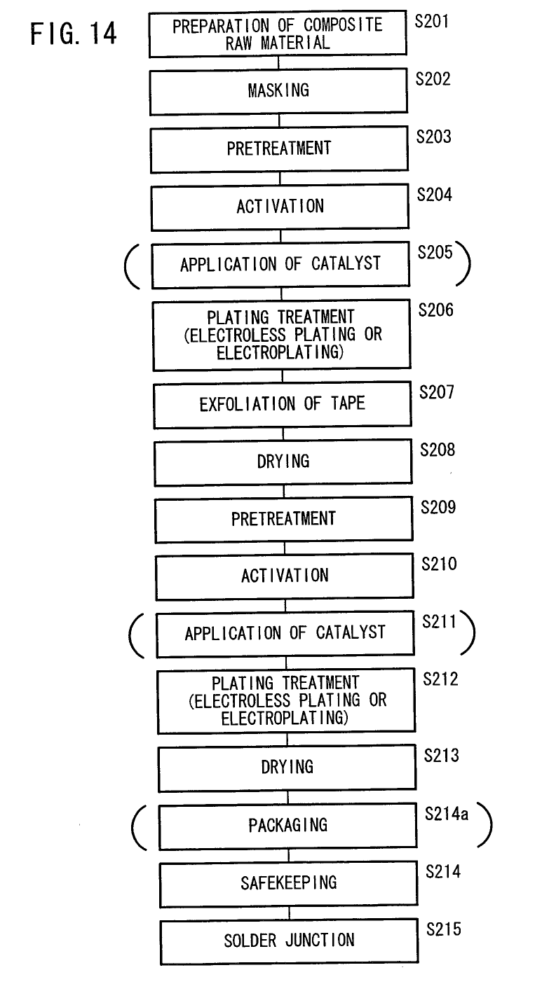

At first, in Step S201 shown in FIG. 14, the composite raw material 16 is prepared. After that, in Step S202, the composite raw material 16 is subjected to the masking. In the masking, a masking tape is stuck to the surfaces (for example, the lower surface and the four side surfaces) except for the joining surface 16a of the entire surface of the composite raw material 16. Of course, for example, a photoresist film can be used in place of the masking tape.

After that, in Step S203, a pretreatment (an alkaline degreasing treatment and a cleaner conditioner treatment) is performed for the composite raw material 16. After that, in Step S204, the surface of the composite raw material 16 is subjected to an activation treatment (an etching treatment and a pickling treatment).

When an electroless plating treatment is performed thereafter, a metal catalyst is applied to the joining surface 16a of the composite raw material 16 and the surface of the masking tape in Step S205 prior to the electroless plating treatment. When an electroplating treatment is performed in place of the electroless plating treatment, the step (Step S205) can be omitted as described above.

After that, in Step S206, the electroless plating treatment is performed to form the thick plating layer 18a on the joining surface 16a of the composite raw material 16 and the surface of the masking tape. As shown in the step of “(5) Electroless plating” in FIG. 7, for example, the electroless plating treatment includes the execution of an electroless plating treatment with NiB after performing an electroless plating treatment with NiP. The favorable thickness of the thick plating layer 18a is 5 to 100 μm, preferably 5 to 50 μm, more preferably 5 to 30 μm, and much more preferably 15 to 25 μm, in the same manner as the thickness of the thick plating layer 18a of the composite material 10B according to the second embodiment.

After that, in Step S207, an exfoliation treatment for the masking tape is performed. As a result of this treatment, the thick plating layer 18a remains only on the joining surface 16a of the composite raw material 16. After that, in Step S208, a drying treatment (a preliminary drying treatment and a main drying treatment) is performed for the composite raw material 16 having the thick plating layer 18a formed on the joining surface 16a.

After that, in Step S209, a pretreatment (an alkaline degreasing treatment and a cleaner conditioner treatment) is performed for the composite raw material 16 after the drying. After that, in Step S210, the surface of the composite raw material 16 is subjected to an activation treatment (a cyanizing activation treatment).

When an electroless plating treatment is performed thereafter, a metal catalyst is applied to the surface of the composite raw material 16 (including the surface of the thick plating layer 18a) in Step S211 prior to the electroless plating treatment. When an electroplating treatment is performed in place of the electroless plating treatment, the step (Step S211) can be omitted as described later on.

After that, in Step S212, the electroless plating treatment is performed to form the thin plating layer 18b on the surface 16a of the composite raw material 16 (including the surface of the thick plating layer 18a) as shown in FIG. 13. As a result of the plating treatment, the laminated plating layer 18, which comprises the thick plating layer 18a and the thin plating layer 18b, is formed on the joining surface 16a of the composite raw material 16.

After that, in Step S213, a drying treatment (a preliminary drying treatment and a main drying treatment) is performed for the composite raw material 16 having the laminated plating layer 18 formed on the joining surface 16a.

Preferred embodiments (for example, atmospheres, hardnesses, temperatures, times, and temperature-raising rates) in Step S208 and Step S213 are equivalent to those used for the composite material 10A described above. Therefore, the explanation thereof is omitted herein.

When the drying treatment in Step S213 comes to an end, the composite material 10C is completed. After that, the composite material 10C is in safekeeping in Step S214. Alternatively, the composite material 10C is packaged (Step S214a depicted in parentheses) and shipped, and it is in safekeeping, for example, by a user.

When necessary, the composite material 10C, which has been in safekeeping, is subjected to the solder junction (Step S215).

The embodiment described above is illustrative of the case in which both of the thick plating layer 18a and the thin plating layer 18b are formed by the electroless plating treatment. Alternatively, the thick plating layer 18a may be formed by the electroless plating and the thin plating layer 18b is formed by the electroplating treatment. It is of course allowable that both of the thick plating layer 18a and the thin plating layer 18b are formed by the electroplating treatment. When the electroplating treatment is performed, it is possible to omit the catalyst application step in Step S205 and Step S211 shown in FIG. 14.

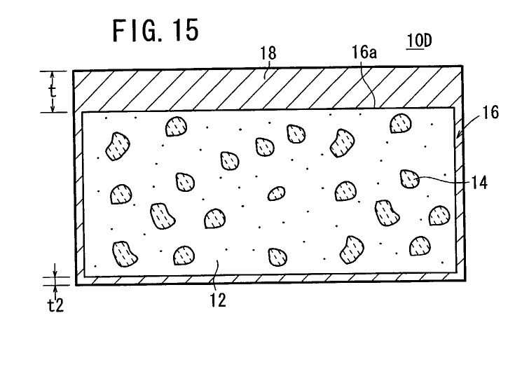

Next, a composite material 10D according to a fourth embodiment will be explained with reference to FIG. 15.

The composite material 10D is constructed in approximately the same manner as the composite material 10A described above. However, as shown in FIG. 15, the composite material 10D is different from the composite material 10A in that a part (for example, a portion corresponding to the lower surface of the composite raw material 16 and/or portions corresponding to the four side surfaces) of a plating layer 18 formed on the entire surface of the composite raw material 16 is subjected to an etching treatment and/or a polishing treatment so that the part of the plating layer 18 is made into a thin film.

In the composite material 10D, when the insulating substrate 20 is joined via the solder layer 24 to the heat sink material of the composite raw material 16, the liquid (for example, the cutting liquid and the plating treatment liquid), which remains in the composite raw material 16, vaporizes and outflows as the gas in the same manner as in the composite material 10B described above. During this process, the vaporization gas keeps away from the portion at which the plating layer 18 to serve as the resistor against the permeation is formed, and the gas outflows through the portion at which the plating layer 18 is made into the thin film.

Accordingly, the composite material 10D also suppresses, for example, the occurrence of cracks, swelling, and exfoliation in the plating layer 18 and the occurrence of voids in the solder layer 24 which would be otherwise caused by the outflow of the vaporization gas.

Further, the composite material 10D also has the plating layer 18 formed on the surface. Therefore, the composite material 10D is handled in a well-suited manner during the soldering. Further, the appearance is satisfactory, and it is possible to reduce the absorption of humidity.

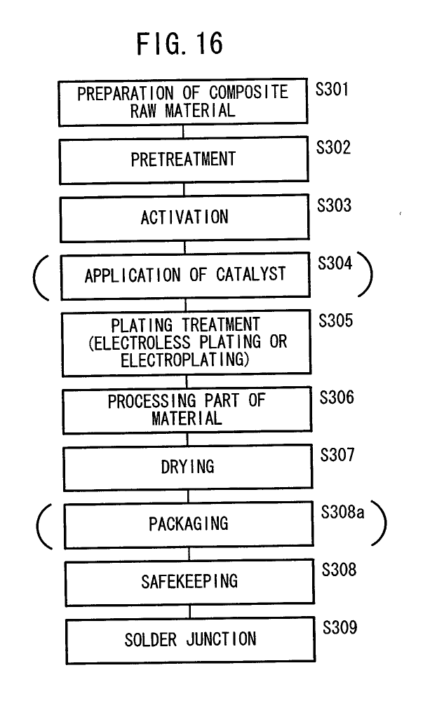

Next, an explanation will be made with reference to FIG. 16 about a specified example (fourth production method) of the method of producing the composite material 10D. The steps same as the ones in the first production method described above will not be detailed.

At first, in Step S301 shown in FIG. 16, the composite raw material 16 is prepared. After that, in Step S302, a pretreatment (an alkaline degreasing treatment and a cleaner conditioner treatment) is performed for the composite raw material 16. Subsequently, in Step S303, the surface of the composite raw material 16 is subjected to an activation treatment (an etching treatment and a pickling treatment).

When an electroless plating treatment is performed thereafter, a metal catalyst is applied to the surface of the composite raw material 16 in Step S304 prior to the electroless plating treatment. When an electroplating treatment is performed in place of the electroless plating treatment, the step (Step S304) can be omitted as described above.

After that, in Step S305, the electroless plating treatment is performed to form the plating layer 18 on the entire surface of the composite raw material 16 as shown in FIG. 15.

As described above, the thickness t of the plating layer 18 is suitably selected so that the vaporization gas of the liquid remaining in the composite raw material 16 is not permeated through the plating layer 18, or so that the open pores existing in the composite raw material 16 can be coated, in the same manner as in the plating layer 18 of the composite material according to the first embodiment. Specifically, the thickness t of the plating layer 18 is 5 to 100 μm, preferably 5 to 50 μm, more preferably 5 to 30 μm, and much more preferably 15 to 25 μm.

After that, in Step S306, the plating layer 18 formed on the entire surface of the composite raw material 16 is partially processed. In this treatment, a part (for example, a portion corresponding to the lower surface of the composite raw material 16 and/or portions corresponding to the four side surfaces) of the plating layer 18 formed on the entire surface of the composite raw material 16 is subjected to an etching treatment and/or a polishing treatment so that the part of the plating layer 18 is made into the thin film.

The thickness t2 of the thin-filmed plating layer 18 is selected so that the remaining liquid is easily vaporized and removed, or so that the vaporization gas of the residual liquid is easily permeated at least as compared with the plating layer 18 on the joining surface 16a. Specifically, the thickness t2 is not more than 10 μm, preferably not more than 5 μm, and more preferably not more than 3 μm.

After that, in Step S307, a drying treatment (a preliminary drying treatment and a main drying treatment) is performed for the composite raw material 16 having the plating layer 18 formed on the surface. Preferred embodiments (for example, atmospheres, hardnesses, temperatures, times, and temperature-raising rates) in the drying treatment are equivalent to those used for the composite material 10A described above. Therefore, the explanation thereof is omitted herein.

At the stage at which the drying treatment in Step S307 comes to an end, the composite material 10D is completed. After that, the composite material 10D is in safekeeping in Step S308. Alternatively, the composite material 10D is packaged (Step S308a depicted in parentheses) and shipped, and it is in safekeeping, for example, by a user.

When necessary, the composite material 10D, which has been in safekeeping, is subjected to the solder junction (Step S309).

The embodiment described above is illustrative of the case in which the plating layer is formed by the electroless plating treatment. Alternatively, it is also allowable that the plating layer is formed by the electroplating treatment. In this procedure, it is possible to omit the catalyst application step in Step S304 shown in FIG. 16.

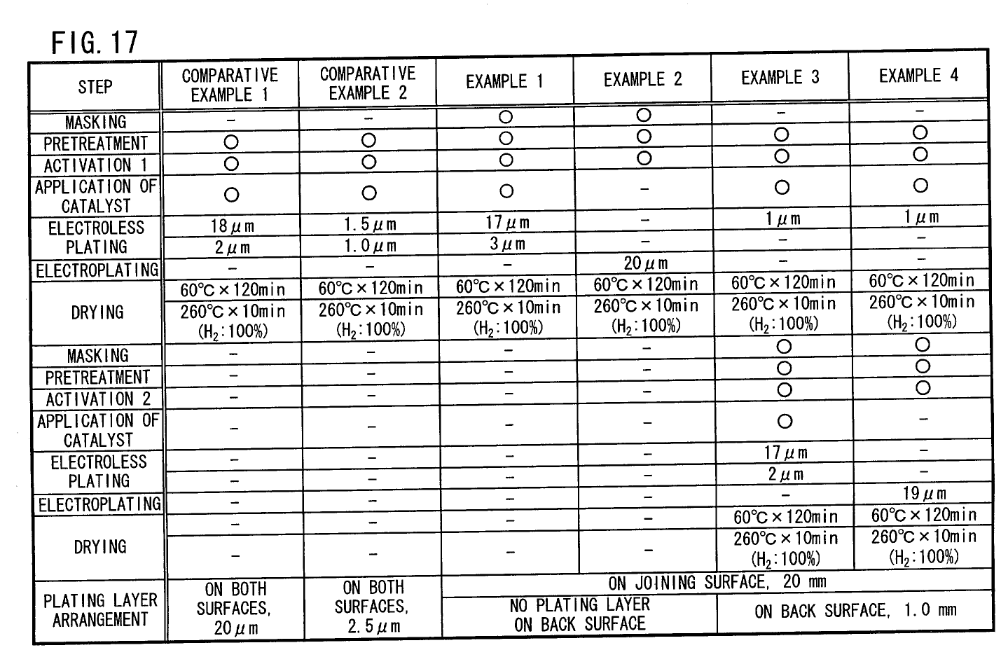

Next, an exemplary experiment will be described. In the exemplary experiment, Comparative Examples 1 and 2 and Examples 1 to 4 are observed as shown in FIG. 17 about the state of appearance of cracks in the plating layer 18, the state of swelling and exfoliation of the plating layer 18, and the state of appearance of voids when the soldering is performed.

Comparative Example 1 concerning the first production method described above shows that a plating layer 18 of 20 μm (NiP plating layer: 18 μm, NiB plating layer: 2 μm) was formed on the both surfaces (or on the entire surface) of the composite raw material 16 by the electroless plating treatment, followed by performing the drying treatment.

Comparative Example 2 concerning the first production method described above shows that a plating layer 18 of 2.5 μm (NiP plating layer: 1.5 μm, NiB plating layer: 1.0 μm) was formed on the both surfaces (or on the entire surface) of the composite raw material 16 by the electroless plating treatment, followed by performing the drying treatment.

Example 1 concerning the first production method described above shows that a plating layer 18 of 20 μm (NiP plating layer: 17 μm, NiB plating layer: 3 μm) was formed on only the joining surface 16a of the composite raw material 16 by the electroless plating treatment, followed by performing the drying treatment.

Example 2 concerning the first production method described above shows that a plating layer 18 of 20 μm (NiP plating layer: 20 μm) was formed on only the joining surface 16a of the composite raw material 16 by the electroplating treatment, followed by performing the drying treatment.

Example 3 concerning the second production method (or the production method concerning the modified embodiment) described above shows that a plating layer 18b of 1 μm (NiP plating layer: 1 μm) was formed on the both surfaces (or the entire surface) of the composite raw material 16 by the electroless plating treatment, followed by performing the drying treatment, and then a plating layer 18a of 19 μm (NiP plating layer: 17 μm, NiB plating layer: 2 μm) was formed on only the joining surface 16a of the composite raw material 16 by the electroless plating treatment, followed by performing the drying treatment.

Example 4 shows that a plating layer 18b of 1 μm (NiP plating layer: 1 μm) was formed on the both surfaces (or the entire surface) of the composite raw material 16 in the same manner as in Example 3, followed by performing the drying treatment, and then a plating layer 18a of 19 μm (NiP plating layer) was formed on only the joining surface 16a of the composite raw material 16 by the electroplating treatment, followed by performing the drying treatment.

In the drying treatment in each of Examples and Comparative Examples, the preliminary drying was performed by maintaining a temperature of 60° C. for 120 hours, and then the main drying was performed by maintaining a temperature of 260° C. for 10 minutes (in an atmosphere of 100% hydrogen).

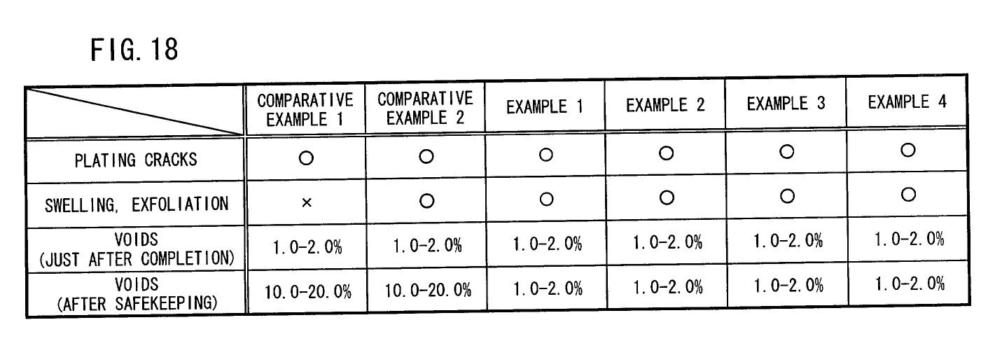

Results of the exemplary experiment are shown in FIG. 18. In FIG. 18, the item of plating cracks indicates the state of cracks in the plating layer 18, in which the circle indicates no appearance and the cross indicates appearance of a lot of cracks in defective state. The item of swelling and exfoliation indicates the swelling and exfoliation state of the plating layer 18, in which the circle indicates no appearance and the cross indicates appearance of a lot of swelling and exfoliation in defective state.

As for the items of voids, the appearance of voids in the solder layer is represented by the percentage in accordance with the following expression. The total area of void portions and the solder junction area were measured with an X-ray transmission photograph.

Void rate (%)=[(total area of void portions)/(solder junction area)]×100

According to the results shown in FIG. 18, no plating cracks appeared in any of Comparative Examples 1 and 2 and Examples 1 to 4. However, a lot of swelling and exfoliation appeared in Comparative Example 1.

As for the void rate in both of Comparative Examples 1 and 2, the void rate is 1.0 to 2.0% just after the completion of the composite raw material 16, in which the composite raw material 16 is sufficiently practically usable. However, after the safekeeping, the void rate is increased to 10.0 to 20.0%, in which the quality is lowered.

On the other hand, in all of Examples 1 to 4, the void rate is 1.0 to 2.0% just after the completion of the composite raw material 16 and after the safekeeping of the composite raw material 16, in which the void rate is low, and the quality is stable.

It is a matter of course that the composite material and the method of producing the same according to the present invention are not limited to the embodiments described above, which may be embodied in other various forms without deviating from the gist or essential characteristics of the present invention.

What is claimed is:

1. A composite material which includes a composite raw material having a porous sintered body infiltrated with a metal and which is joined to another object by a junction layer, said composite material comprising:
a plating layer formed at least on a portion of a surface of said composite raw material at which said junction layer is formed.

2. The composite material according to claim 1, wherein said plating layer comprises only a first plating layer, or said plating layer comprises said first plating layer and a second plating layer.

3. The composite material according to claim 2, wherein said plating layer comprises said first plating layer and said second plating layer, and only said first plating layer is formed at least on said portion of said surface of said composite raw material at which said junction layer is formed.

4. The composite material according to claim 2, wherein said plating layer comprises said first plating layer and said second plating layer, said first plating layer is formed at least on said portion of said surface of said composite raw material at which said junction layer is formed, and said second plating layer is formed at least on a part of said first plating layer at which said junction layer is formed.

5. The composite material according to claim 2, wherein a rate of voids in said junction layer generated by vaporization gas permeated through said first plating layer is not more than 3%.

6. The composite material according to claim 2, wherein a degree of leakage of said first plating layer is not more than 5.0×10⁻¹⁰ cc-atm/sec.

7. The composite material according to claim 2, wherein said first plating layer coats not less than 90% in area ratio of open pores existing in said surface of said composite raw material.

8. The composite material according to claim 2, wherein said first plating layer is formed by electroless plating, and said first plating layer has no plating crack.

9. The composite material according to claim 2, wherein said first plating layer is formed by electroless plating, and said first plating layer has a hardness which is not more than 80% of a maximum hardness.

10. The composite material according to claim 2, wherein said first plating layer is formed by electroplating.

11. The composite material according to claim 2, wherein said first plating layer comprises a layer formed by electroless plating and a layer formed by electroplating.

12. The composite material according to claim 2, wherein a thickness of said first plating layer is selected so that no vaporization gas is permeated therethrough.

13. The composite material according to claim 2, wherein said first plating layer has a thickness which is at least twice as long as a diameter of an open pore existing in said surface of said composite raw material.

14. The composite material according to claim 2, wherein said first plating layer has a thickness of 5 to 100 μm.

15. The composite material according to claim 2, wherein said first plating layer has a thickness of 5 to 50 μm.

16. The composite material according to claim 2, wherein a thickness of said second plating layer is selected so that residual liquid is easily vaporized and removed.

17. The composite material according to claim 2, wherein said second plating layer allows vaporization gas of residual liquid to permeate therethrough more than at least said first plating layer does.

18. The composite material according to claim 2, wherein said second plating layer has a thickness of not more than 10 μm.

19. The composite material according to claim 2, wherein said second plating layer has a thickness of not more than 5 μm.

20. The composite material according to claim 2, wherein a degree of leakage of said second plating layer is not less than 5.0×10⁻¹⁰ cc-atm/sec.

21. The composite material according to claim 2, wherein said second plating layer is formed by electroless plating or electroplating or both of electroless plating and electroplating.

22. A method of producing a composite material which includes a composite raw material having a porous sintered body infiltrated with a metal and which is joined to another object by a junction layer, said method comprising:
forming a plating layer at least on a portion of a surface of said composite raw material at which said junction layer is formed.

23. The method of producing said composite material according to claim 22, wherein said plating layer comprises only a first plating layer, or said plating layer comprises said first plating layer and a second plating layer.

24. The method of producing said composite material according to claim 23, wherein said plating layer comprises said first plating layer and said second plating layer, and only said first plating layer is formed at least on said portion of said surface of said composite raw material at which said junction layer is formed.

25. The method of producing said composite material according to claim 23, wherein said plating layer comprises said first plating layer and said second plating layer, said first plating layer is formed at least on said portion of said surface of said composite raw material at which said junction layer is formed, and said second plating layer is formed at least on a part of said first plating layer at which said junction layer is formed.

26. The method of producing said composite material according to claim 23, comprising a step of applying a masking treatment to surface portions other than said portion on which said first plating layer is formed.

27. The method of producing said composite material according to claim 23, including the steps of:
forming said second plating layer;
subsequently, applying a masking treatment to said second plating layer other than a portion on which said first plating layer is formed; and
subsequently, forming said first plating layer.

28. The method of producing said composite material according to claim 23, wherein said first plating layer and said second plating layer are formed by repeating n times a series of treatments each comprising performing a plating treatment and subsequently performing a drying treatment.

29. The method of producing said composite material according to claim 28, wherein a temperature and a period of time for said drying treatment are selected so that at least water is capable of being removed by vaporization.

30. The method of producing said composite material according to claim 28, wherein said drying treatment comprises retaining an arbitrary temperature within a range of 30 to 600° C. for an arbitrary period of time within a range of 1 to 300 minutes.

31. The method of producing said composite material according to claim 28, wherein said drying treatment comprises retaining an arbitrary temperature within a range of 200 to 400° C. for an arbitrary period of time within a range of 1 to 300 minutes.

32. The method of producing said composite material according to claim 28, wherein said drying treatment is performed in an atmosphere in which oxidation of said plating layer is suppressed.

33. The method of producing said composite material according to claim 32, wherein said atmosphere is selected from an inert gas atmosphere, a vacuum atmosphere, and a reducing atmosphere.

34. The method of producing said composite material according to claim 33, wherein said reducing atmosphere is an atmosphere in which hydrogen is included not less than 3%.

35. The method of producing said composite material according to claim 33, wherein said reducing atmosphere is an atmosphere in which hydrogen is included not less than 30%.

36. The method of producing said composite material according to claim 33, wherein said reducing atmosphere is an atmosphere in which hydrogen is included not less than 90%.

37. The method of producing said composite material according to claim 28, wherein said drying treatment is performed at a temperature-raising rate at which no swelling occurs in said first plating layer and said second plating layer.

38. The method of producing said composite material according to claim 37, wherein said temperature-raising rate is not more than 400° C./hr.

39. The method of producing said composite material according to claim 37, wherein said temperature-raising rate is not more than 100° C./hr.

40. The method of producing said composite material according to claim 28, wherein said drying treatment is carried out in accordance with a heat program to retain a temperature in the vicinity of a vaporization temperature of residual liquid.
